(19) United States
(12) Patent Application Publication
(10) Pub. No.: US 2008/0212895 A1
(43) Pub. Date: Sep. 4, 2008

(54) Image data processing techniques for highly undersampled images

(75) Inventor: Barry G. Mattox, Orlando, FL (US)

Correspondence Address: BUCHANAN, INGERSOLL & ROONEY PC, POST OFFICE BOX 1404, ALEXANDRIA, VA, 22313-1404, US

(73) Assignee: LOCKHEED MARTIN CORPORATION, Bethesda, MD (US)

(21) Appl. No.: 12/007,358

(22) Filed: Jan. 9, 2008

Related U.S. Application Data
(60) Provisional application No. 60/879,325, filed on Jan. 9, 2007.

(51) Int. Cl. G06K 9/32

(52) U.S. Cl. 382/294

(57) ABSTRACT

An exemplary method for processing undersampled image data includes: aligning an undersampled frame comprising image data to a reference frame; accumulating pixel values for pixel locations in the aligned undersampled frame; repeating the aligning and the accumulating for a plurality of undersampled frames; assigning the pixel values accumulated for the pixel locations in the aligned undersampled frames to closest corresponding pixel locations in an upsampled reference frame; and populating the upsampled frame with a combination of the assigned pixel values to produce a resulting frame of image data.

### CROSS-REFERENCE TO RELATED APPLICATIONS

This application claims the benefit of U.S. Provisional Patent Application No. 60/879,325, filed Jan. 9, 2007, the disclosure of which is herein incorporated by reference in its entirety.

### FIELD OF THE DISCLOSURE

The present disclosure relates to image data processing, and to processing which reduces aliasing caused by the undersampling of images.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art.

A focal plane array (FPA) is a device that includes pixel elements, also referred to herein as detector elements, which can be arranged in an array at the focal plane of a lens. The pixel elements operate to detect light energy, or photons, by generating, for instance, an electrical charge, a voltage or a resistance in response to detecting the light energy. This response of the pixel elements can then be used, for instance, to generate a resulting image of a scene that emitted the light energy. Different types of pixel elements exist, including, for example, pixel elements that are sensitive to, and respond differently to, different wavelengths/wavebands and/or different polarizations of light. Some FPAs include only one type of pixel element arranged in the array, while other FPAs exist that intersperse different types of pixel elements in the array.

For example, a single FPA device may include pixel elements that are sensitive to different wavelengths and/or to different polarizations of light. To utilize such arrays without grossly undersampling the resulting image detected by the pixel elements that are sensitive to one particular wavelength (or polarization), causing aliasing (e.g., distortion) in the resulting image, can require giving up the fundamental resolution of an individual detector element's dimensions by broadening the point spread function (PSF). The PSF of a FPA or other imaging system represents the response of the system to a point source. The width of the PSF can be a factor limiting the spatial resolution of the system, with resolution quality varying inversely with the dimensions of the PSF. For instance, the PSF can be broadened so that it encompasses not only a single pixel element, but also the space between like types of pixel elements (that is, the space between like-wavelength sensitive or like-polarization sensitive pixel elements), where the spaces between same-sense pixel elements are occupied by pixel elements of other wavelength/polarization sensitivities. Enlarging the PSF, however, not only degrades resolution of the resulting image, but also reduces energy on any given pixel element, thereby reducing the signal-to-noise ratio (SNR) for the array.

### SUMMARY

An exemplary method for processing undersampled image data includes: aligning an undersampled frame comprising image data to a reference frame; accumulating pixel values for pixel locations in the aligned undersampled frame; repeating the aligning and the accumulating for a plurality of undersampled frames; assigning the pixel values accumulated for the pixel locations in the aligned undersampled frames to closest corresponding pixel locations in an upsampled reference frame; and populating the upsampled frame with a combination of the assigned pixel values to produce a resulting frame of image data.

Another exemplary method for processing undersampled image data includes: aligning an undersampled frame comprising image data to a reference frame; assigning pixel values for pixel locations in the aligned undersampled frame to closest corresponding pixel locations in an upsampled reference frame; combining, for each upsampled pixel location, the pixel value or values assigned to the upsampled pixel location with a previously combined pixel value for the upsampled pixel location and incrementing a count of the number of pixel values assigned to the upsampled pixel location; repeating the aligning, the assigning, and the combining for a plurality of undersampled frames; and normalizing, for each upsampled pixel location, the combined pixel value by the count of the number of pixel values assigned to the upsampled pixel location to produce a resulting frame of image data.

An exemplary system for processing undersampled image data includes an image capture device and a processing device configured to process a plurality of undersampled frames comprising image data captured by the image capture device. The processing device is configured to process the undersampled frames by aligning each undersampled frame to a reference frame, accumulating pixel values for pixel locations in the aligned undersampled frames, assigning the pixel values accumulated for the pixel locations in the aligned undersampled frames to closest corresponding pixel locations in an upsampled reference frame, and populating the upsampled frame with a combination of the assigned pixel values to produce a resulting frame of image data.

Another exemplary system for processing undersampled image data includes an image capture device and a processing device. The processing device is configured to align an undersampled frame comprising image data captured by the image capture device to a reference frame, assign pixel values for pixel locations in the aligned undersampled frame to closest corresponding pixel locations in an upsampled reference frame, and combine, for each upsampled pixel location, the pixel value or values assigned to the upsampled pixel location with a previously combined pixel value for the upsampled pixel location and increment a count of the number of pixel values assigned to the upsampled pixel location. The processing device is also configured to repeat the aligning, the assigning, and the combining for a plurality of undersampled frames and, for each upsampled pixel location, normalize the combined pixel value by the count of the number of pixel values assigned to the upsampled pixel location to produce a resulting frame of image data.

### BRIEF DESCRIPTION OF THE DRAWINGS

Other objects and advantages of the invention will become apparent to those skilled in the relevant art(s) upon reading the following detailed description of preferred embodiments, in conjunction with the accompanying drawings, in which like reference numerals have been used to designate like elements, and in which:

FIG. 1 illustrates a flow diagram of an exemplary interpolation technique for processing undersampled images;

FIGS. 2A and 2B illustrate flow diagrams of exemplary accumulation techniques for processing undersampled images;

FIG. 3 illustrates an exemplary system for processing undersampled images;

FIGS. 4A-4J illustrate exemplary micropolarizer patterns and characteristics thereof;

FIGS. 5A-5F provide a legend for interpreting the simulation results depicted in FIGS. 6A-6E;

FIGS. 6A-6H illustrate simulation results comparing the performance of two processing techniques; and

FIGS. 7A and 7B illustrate optical flow, particularly as a function of off-axis scan angle.

### DETAILED DESCRIPTION

### Overview

Techniques are described herein for processing image data captured by an imaging system, such as, but not limited to, a focal plane array (FPA) having different types of detector elements interspersed in the array. For example, a frame of image data captured by all of the types of the detector elements interspersed in the FPA can be effectively separated into several image frames, each separated image frame including only the image data captured by one of the types of the detector elements. Because like-type, or same-sense, detector elements can be spaced widely apart in the FPA, separating the image frames according to like-type detector elements produces undersampled image frames that are susceptible to the effects of aliasing. In another example, an FPA having like-type detectors that are relatively small and widely-spaced apart also produces undersampled image frames that are susceptible to the effects of aliasing.

Different techniques are described herein for processing undersampled image frames. These techniques can be applied irrespective of how the undersampled image frames are obtained. In particular, techniques are described for processing the pixels of undersampled image frames to compute image data values for locations in an upsampled frame. As used herein, the term “upsampled” refers to pixel locations that are spaced at different intervals than the spacing of the undersampled frames. Typically, the pixels of the upsampled frame are spaced sufficiently close to avoid undersampling in the Nyquist sense, but the upsampled frame need not be limited to such spacing, and other spacings are possible. In embodiments, the upsampled frame is referred to as a “resampled” or “oversampled” frame. A detailed description of an accumulation technique for processing undersampled frames is presented herein, in accordance with one or more embodiments of the present disclosure. The explanation will be by way of exemplary embodiments to which the present invention is not limited.

### Interpolation Technique for Processing Undersampled Images

In one technique for processing undersampled images, interpolation can be performed on the pixels of a given undersampled frame to compute image data values for locations in an upsampled frame. The upsampled frames, thus populated with values interpolated from the undersampled frames, can then be combined, for example, by averaging the frames, to produce a resulting image frame. Such averaging of the frames can reduce the effects of aliasing in the original undersampled image, and can also improve the SNR of the resulting image. Having reduced the aliasing effects (which occur mostly in the higher-frequency regions), image sharpening filters can also be used to enhance edges, somewhat improving the resolution of the resulting image.

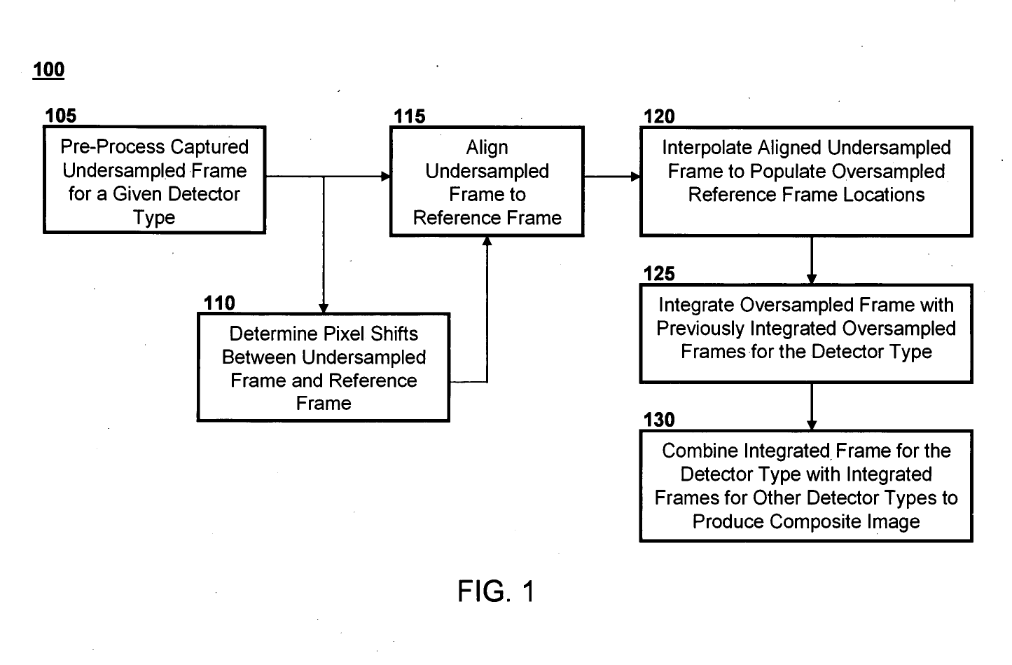

FIG. 1 illustrates an exemplary interpolation technique 100 for processing undersampled images. In step 105, a captured undersampled frame of image data for a particular detector type is pre-processed. As described herein, a FPA having different types of detector elements interspersed in the array can be used to capture a frame of image data, which can then be separated into undersampled image frames according to type of detector element. Pre-processing the undersampled image frame can include, for example, performing non-uniformity correction, dead-pixel replacement and pixel calibration, among other processes.

The image capture device can experience a two-dimensional, frame-to-frame, angular dither. The dithering in two dimensions can be either deterministic or random. When dither is not known, shift estimation processing can be preformed, frame-to-frame, to estimate the horizontal and vertical dither shifts so that all frames can be aligned (or registered) to one another before frame integration. Thus, in step 110, integer and fractional shifts in pixel locations between the undersampled frame and a reference frame are determined. The reference frame for a given type of detector element can include, but is not limited to, the first undersampled frame captured during the process 100, a combination of the first several undersampled frames captured during the process 100, an upsampled frame, etc. To determine the shifts, correlation of the undersampled frame and the reference frame can be performed, among other approaches, where the result of the correlation (e.g., a shift vector) describes the two-dimensional shift of the pixel locations in the undersampled frame with respect to the pixel locations in the reference frame.

Then, in step 115, the undersampled image frame is aligned to the reference frame based on the pixel shifts determined in step 110. The alignment performed in step 115 is also referred to herein as frame “registration.” U.S. Pat. No. 7,103,235, issued Sep. 5, 2006, which is incorporated by reference herein in its entirety, provides a detailed description of techniques that can be employed to perform shift estimation and frame registration in accordance with steps 110 and 115. To produce a higher resolution resulting image, pixel values in the aligned/registered undersampled frame can be upsampled to populate pixel locations in an upsampled reference frame. The upsampled reference frame might include, for example, four times as many pixel locations as the undersampled frame. Thus, in step 120, upsampling is performed by interpolating (e.g., bilinear interpolation) the pixels of the aligned undersampled frame to compute image data values for the pixel locations in the upsampled reference frame that do not already exist in the aligned undersampled frame.

In step 125, the populated upsampled frame is combined, or integrated, with previously integrated upsampled frames for the same type of detector. The integration can include, for example, averaging the upsampled frames to produce a resulting image frame for the same type of detector. Integration of multiple frames can result in an improvement in SNR that is proportional to the square root of the number of frames integrated.

Then, in step 130, the integrated frame for a given type of detector element can be combined with the integrated frames generated for the other types of detector elements in the FPA to produce a composite image frame. For example, if the FPA includes different types of wavelength-sensitive detector elements interspersed in the array, such as red, blue and green wavelength-sensitive detector types, then the integrated frame generated for the red detector type can be combined with the integrated frames generated for the blue and green detector types to produce the composite image frame. Similarly, in another example, if the FPA includes different types of polarization-sensitive detector elements interspersed in the array, such as detector elements having −45 degree, horizontal, vertical and +45 degree polarization sensitivities, then the integrated frame generated for the −45 degree detector type can be combined with the integrated frames generated for the horizontal, vertical and +45 degree detector types to produce the composite image.

Because most of the upsampled locations are populated by interpolation across multiple-pixel separations (that is, with smeared values from combinations of detector elements), the resolution of the image generated by the interpolation process 100 can be limited by the PSF, detector size, and detector spacing. That is, for the interpolation technique, spot size is typically matched to the spacing of like detector elements.

### Accumulation Processing Technique for Undersampled Images

As described herein in conjunction with FIG. 1, the pixels of an undersampled image frame can be interpolated to populate the pixel locations of an upsampled frame. The interpolation, combined with frame integration, can reduce the aliasing effects caused by undersampling, but the interpolation can also blur each frame, thus degrading the resolution of both the individually interpolated frames and the integrated frame relative to the resolution of the pixels of the undersampled image frames. In the interpolation technique of the process 100, the registration and upsampling steps involve interpolation among several detector elements, thereby smearing the resulting image, where the resulting resolution is on the order of the spacing between detector elements, as opposed to on the order of the dimensions of individual detector elements.

Another technique for processing undersampled images is described herein that can efficiently use FPAs with widely spaced detector elements in a manner that can reduce aliasing produced by undersampling, while, at the same time, can maintain the inherent resolution of individual detector element dimensions. In accordance with this technique, the pixel samples of dithered undersampled frames can be accumulated and assigned to nearest pixel locations in an upsampled reference frame. In this manner, most, if not all, of the upsampled locations can be populated by values from single detector elements, thereby avoiding interpolating and populating the upsampled locations with smeared values from combinations of detector elements. Accordingly, the inherent resolution of individual detector dimensions can be maintained.

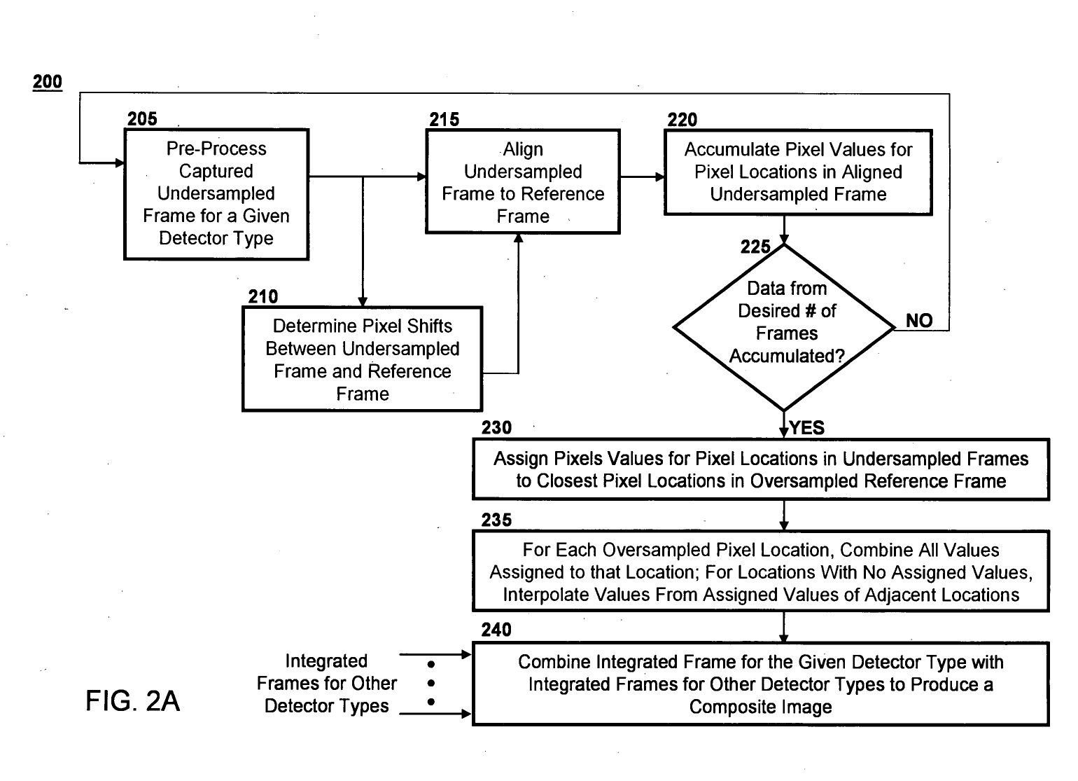

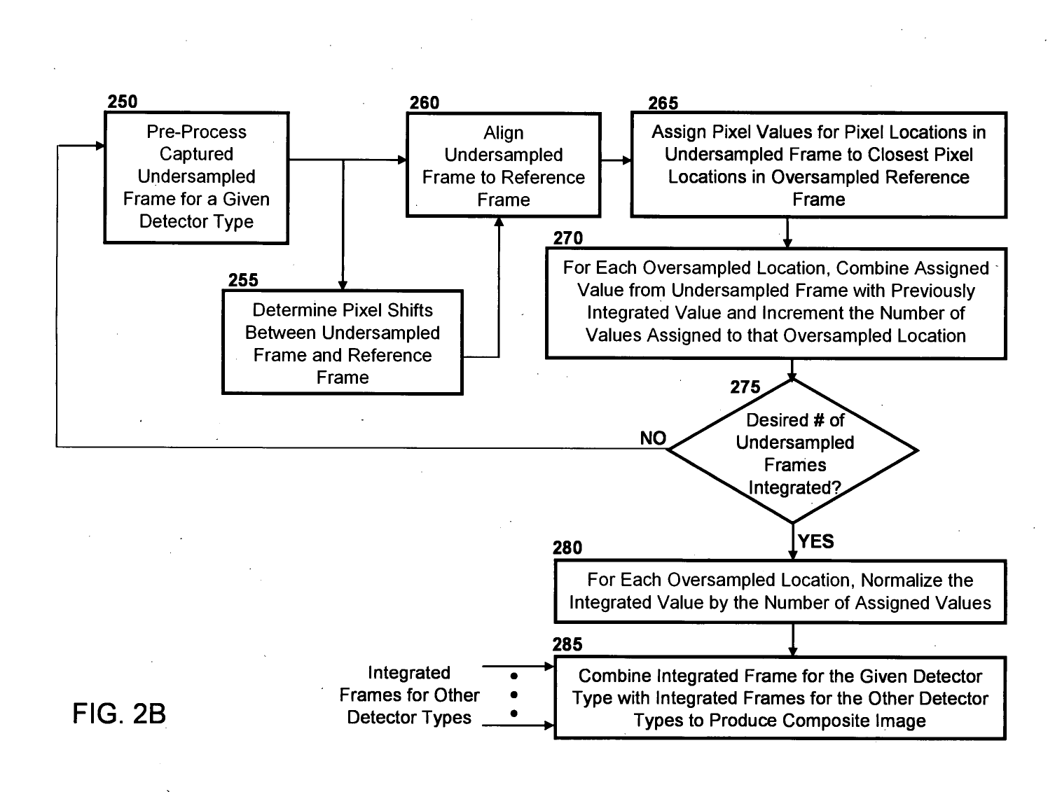

FIGS. 2A and 2B illustrate exemplary accumulation techniques for processing undersampled images, in accordance with embodiments of the present disclosure. Not all of the steps of FIGS. 2A and 2B have to occur in the order shown, as will be apparent to persons skilled in the art based on the teachings herein. Other operational and structural embodiments will be apparent to persons skilled in the art based on the following discussion. These steps are described in detail below.

FIG. 2A illustrates an exemplary accumulation technique 200 for processing undersampled images according to an embodiment of the present disclosure. In step 205, a captured undersampled frame of image data for a particular detector type is pre-processed. As in the process 100, a FPA, among other types of imaging systems, having different types of detector elements interspersed in an array, can be used to capture a frame of image data, which can then be separated into undersampled image frames according to type of detector element. As described herein, pre-processing the undersampled image frame can include, for example, performing non-uniformity correction, dead-pixel replacement and pixel calibration, among other processes.

In one embodiment, dither can be used to obtain pixel samples at locations in the undersampled frames that, after registration, are close to all or most of the upsampled pixel locations. In order to populate all or most of the upsampled pixel locations using this technique, random and/or deterministic relative motion between an image capture device and the scene being imaged and/or angular dither of the image capture device are needed so that the closest upsampled pixels to the undersampled detector pixels are not always the same. The relative positions of the aligned undersampled pixels to the upsampled reference pixels resulting from the motion/dither allows contributions to be applied to most, if not all, of the upsampled reference pixels after several undersampled frames have been processed.

For example, the process 200 can be implemented in a variety of image capture systems, including staring systems (e.g., the array captures an image without scanning), step-stare systems and slowly scanning systems, among others, where dither can be supplied by platform motion, gimbal motion, and/or mirror dither motion of these systems. Such motion can be intentional or incidental, and may be deterministic or random. For example, in a step-stare system, the dither may be supplied by back-scanning less than the amount needed to completely stabilize the image on the detector array while scanning the gimbal.

As described herein, if the dither is not known, processing can be performed frame-to-frame to estimate the dither shifts in two dimensions in order to register the captured image frames to one another. Thus, in step 210, integer and fractional shifts in pixel locations between the undersampled frame and a reference frame are determined. As in the process 100, the reference frame for a given type of detector element in the process 200 can include, but is not limited to, the first undersampled frame captured during the process 200, a combination of the first several undersampled frames captured during the process 200, an upsampled frame, etc. Further, as described herein, the undersampled frame and the reference frame can be correlated, among other approaches, the result of which describes the two-dimensional shift of the pixel locations in the undersampled frame with respect to the pixel locations in the reference frame.

In step 215, the undersampled image frame is aligned to the reference frame based on the pixel shifts determined in step 210. Details of the alignment/registration performed in step 215 are described herein with repsect to correpsonding step 115 of the process 100 and are not repeated here. Registration of frames can be performed in software so that registration is not a function of mechanical vibration or temperature. Additionally, registration of the multiple polarization/wavelength detector sensitivities can be known and consistent because the physical arrangement of the detector elements in the FPA is known. Thus, in one embodiment, the pixel shifts determined for each type of detector element can be determined and combined (e.g., averaged), and the undersampled image frame for a given type of detector element can be aligned using the average shift determined based on all of the types of detector elements, as opposed to the shift determined based on one given type of detector element.

In step 220, pixel values for pixel locations in the aligned undersampled frame are accumulated. In step 225, it is determined whether data from a desired number of undersampled frames has been accumulated. If not, undersampled frames continue to be processed in accordance with steps 205-220 until data from the desired number of undersampled frames has been accumulated. In an embodiment, the accumulated data can be stored, for example, in a table in memory.

When data from the desired number of undersampled frames has been accumulated, upsampling is performed in step 230 by assigning the pixel values accumulated for the pixel locations of the aligned undersampled frames processed in steps 205-220 to closest corresponding pixel locations in an upsampled reference frame. That is, the pixel values from the aggregate of the pixel values accumulated from all of the processed undersampled frames can be assigned to closest pixel locations in the upsampled image. As described herein, the upsampled reference frame might include, for example, four times as many pixel locations as the undersampled frame, but the dithering and subsequent re-aligning of a frame can cause that frame's pixels to fall in various locations in between the original undersampled pixel locations, providing samples for most, if not all, of the pixel locations in the upsampled image.

In an embodiment, in step 230, each of the accumulated pixel values (e.g., pixel values from more than one undersampled frame) are assigned to an upsampled pixel location. For each pixel value from a registered, undersampled frame, the assigned location can be the upsampled reference location that is closest to the undersampled pixel location after registration shifts. Then, in step 235, all values assigned to the same location are combined (e.g., averaged) and the combined value is used to populate that location. In the process 200, to obtain image samples for locations of the upsampled image, the data from an entire set of undersampled frames can be collected. This aggregate can contain samples at locations which, after dithering and re-aligning, occur at locations closest to locations of most, if not all, of the upsampled pixel locations to be populated.

In an embodiment, in step 235, those locations in the upsampled frame for which no samples have been accumulated can be populated by copying or interpolating the nearest populated neighboring pixel values. Such interpolation can include, for example, bilinear or a simple nearest-neighbor interpolation. Because few locations in the upsampled frame are likely to be unpopulated by undersampled image data, only a small degree of resolution is likely to be affected by performing interpolation to fill in values for the unpopulated locations.

The image frame resulting from step 235 is referred to herein as an “integrated frame” because it includes a combination of data collected from a number of undersampled frames. As described herein, the integrated frame can experience an improvement in SNR that is proportional to the square root of the number of frames integrated. In an embodiment, image sharpening filters can be applied to enhance edges of the integrated image, since aliasing noise, which can be exacerbated by image sharpening filters, can also been reduced as a result of the intergration process. In one embodiment, the number of frames processed and integrated can be based on whether the scene being imaged is undergoing motion. For example, if portions of the scene being imaged are undergoing motion relative to other scene components, fewer frames may be processed and integrated to avoid blurring those portions in the integrated frame.

As described herein, because the physical arrangement of the pixels in the imaging device (e.g., FPA) is known, in step 240, the integrated frame for the given type of detector can be combined with the integrated frames generated for the other types of detector elements in the imaging device to produce a composite image. For example, such composite image could be displayed on a display device for a human viewer, or could be processed by a computer application, such as an automatic target recognition application or a target tracking application, among other applications that can process data captured from multiple waveband/polarization detectors.

In another embodiment of process 200, illustrated in FIG. 2B, it is not necessary to defer integration until after data from a subgroup/collection of undersampled frames of has been accumulated. Rather, data can be integrated on a frame-by-frame basis. In FIG. 2B, steps 250, 255 and 260 are identical to steps 205, 210 and 215, illustrated in FIG. 2A. In FIG. 2B, however, pixel values for pixel locations in each undersampled frame are assigned to closest pixel locations in the upsampled reference frame, in step 265, on a frame-by-frame basis. In step 270, for each upsampled location, the value from the undersampled frame assigned to that upsampled location is combined (e.g., added) to the previously integrated value for that upsampled location, and the number of values assigned to that upsampled location is incremented. In step 275, it is determined whether a desired number of undersampled frames have been integrated. Once integration is complete, in step 280, the integrated value for each upsampled location is normalized (e.g., divided) by the number of values assigned to that upsampled location. As in step 240 of FIG. 2A, the integrated frame for a given type of detector element may be combined with integrated frames for other types of detector elements of the image capture device to produce a composite image in step 285 of FIG. 2B.

By integrating the aggregate data of dithered frames of data, embodiments of the process 200 can overcome both the resolution degradation and the SNR reduction experienced as a result of the interpolation processing technique 100. Moreover, for embodiments of the process 200, resolution of the resulting image can be, in some instances, limited by the PSF and detector size, but not by the detector spacing. For example, spot size can be matched to the detector size for optimum resolution and SNR. Thus, in embodiments of the process 200, resolution on the order of the resolution of the detector/PSF combination can be achieved, rather than being degraded by interpolation across multiple-pixel separations, as in the process 100.

### Exemplary System for Processing Undersampled Images

The processing techniques described herein in accordance with embodiments of the present disclosure can have many suitable applications including, but not limited to, electro-optical (EO) targeting systems, particularly those EO systems that utilize polarization and/or waveband differentiation imaging; high-definition television (e.g., improved resolution using a reduced number of detection elements); and still and/or video cameras (where processing can be traded for sensor costs and/or increased performance, especially where multicolor, multi-waveband or multiple-polarization information is needed). In these systems, a FPA can be divided so that a basic repeating pixel pattern includes pixels of varying polarizations and/or wavebands.

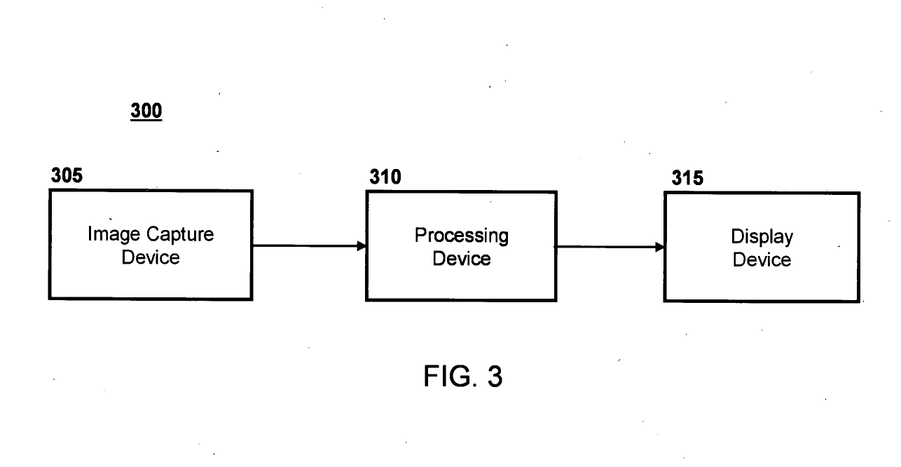

FIG. 3 illustrates an exemplary system 300 for processing undersampled images. System 300 includes an image capture device 305. Image capture device 305 can be implemented with, but is not limited to, a FPA having a plurality of detector elements arranged in an array. The detector elements can have the same or different wavelength/waveband and/or polarization sensitivities. As described herein, in embodiments, different detector elements can be arranged in basic repeating patterns in the array, with a particular pattern being selected based on a type of motion expected to be encountered in a scene being imaged by the image capture device 305.

System 300 also includes a processing device 310. In accordance with an aspect of the present disclosure, the processing device 310 can be implemented in conjunction with a computer-based system, including hardware, software, firmware, combinations thereof. In an embodiment, the processing device 310 can be configured to implement the steps of the embodiments of the exemplary accumulation process 200, illustrated in FIGS. 2A and 2B.

The processing device 310 can be configured to align an undersampled frame, which includes image data captured by a given one of the plurality of different types of detector elements of the image capture device 305, to a reference frame. For example, in an embodiment, the processing device can be configured to determine integer and fractional pixel shifts between the undersampled frame and the reference frame. As described herein, the reference frame can include, but is not limited to, the first undersampled frame, a combination of the first several undersampled frames for the given type of detector element, an upsampled frame, etc. Accordingly, in one embodiment, the processing device 310 can be configured to align the undersampled frame to the reference frame based on the pixel shifts. In an embodiment, the processing device 310 can be configured to pre-process the undersampled image prior to aligning the undersampled frame with the reference frame. As described herein, such pre-processing can include, but is not limited to, non-uniformity correction, dead-pixel replacement and pixel calibration.

The processing device 310 can also be configured to accumulate pixel values for pixel locations in the undersampled frame and populate pixel locations in an upsampled reference frame by combining (e.g., averaging) the accumulated pixel values from the undersampled pixel values whose registered locations are closest to a given upsampled pixel location. In embodiments, the resulting integrated image frame can experience an improvement in SNR that is proportional to the square root of the number of frames integrated.

In an embodiment, the undersampled frame includes dithered image data. As described herein, the dithering and subsequent re-aligning of a frame can cause that frame's pixels to fall in various locations in between the original undersampled pixel locations, providing samples for most, if not all, of the pixel locations in the upsampled frame. For example, as described herein, the image capture device 305 can experience a two-dimensional, frame-to-frame, angular dither. Such dither can be supplied by, among other techniques, platform motion, gimbal motion, and/or mirror dither motion of the image capture device 305 and the motion can be intentional or incidental, and may be deterministic or random.

In an embodiment, the processing device 310 can be configured to accumulate all of the pixel values for a number of undersampled frames before assigning and integrating the accumulated values to upsampled pixel locations, as illustrated in FIG. 2A. If more than one pixel value has been accumulated and assigned to a particular upsampled pixel location, the processing device 310 can be configured to combine (e.g., average) the assigned pixel values and populate to the upsampled pixel location with the combined value. Additionally, if unpopulated pixel locations exist in the upsampled frame after assigning the accumulated pixel values, then the processing device 310 can be configured to interpolate the pixel values of the nearest populated pixel locations to populate the unpopulated pixel locations in the upsampled frame.

In another embodiment, the processing device 310 can be configured to assign and integrate the undersampled pixel values to upsampled pixel locations on a frame-by-frame basis, as illustrated in FIG. 2B. In this embodiment, the processing device 310 can be configured to assign pixel values for locations in an undersampled frame to closest locations in the upsampled reference frame and, for each upsampled location, combine the assigned value with a previously integrated value for that upsampled location and increment the number of values assigned to that upsampled location. After a desired number of frames have been integrated, the processing device 310 can be configured to normalize (e.g., divide) the integrated value for each upsampled location by the number of assigned values for that upsampled location.

In an embodiment, the processing device 310 can be configured to process undersampled frames for each of the different types of detector elements in parallel to produce resulting image frames for each of the different types of detector elements of the image capture device 305. Further, the processing device 310 can be configured to combine the integrated frame for one type of detector element with the integrated frames for the other types of detector elements to produce a composite image. For example, the integrated frames might be combined according to color (such as for color television), pseudo-color (e.g., based on polarizations), multi-band features (e.g., for automatic target recognition), polarization features, etc. Such a composite image can be displayed by a display device 315 for a human viewer and/or can be further processed by computer algorithms for target tracking, target recognition, and the like.

### FPA Detector Pattern Selection

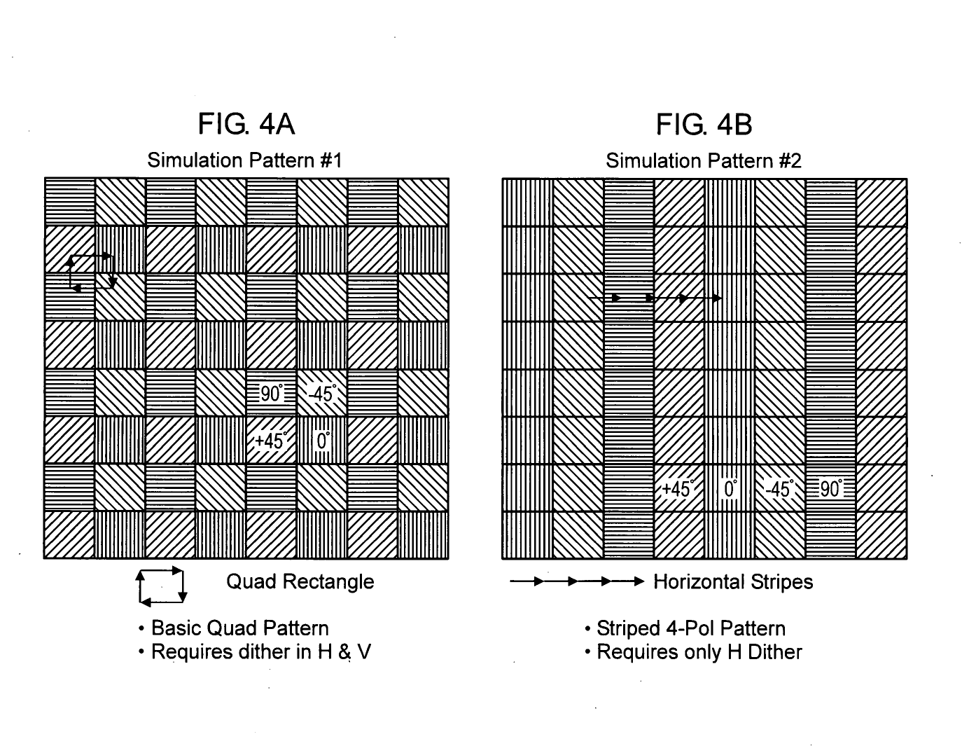

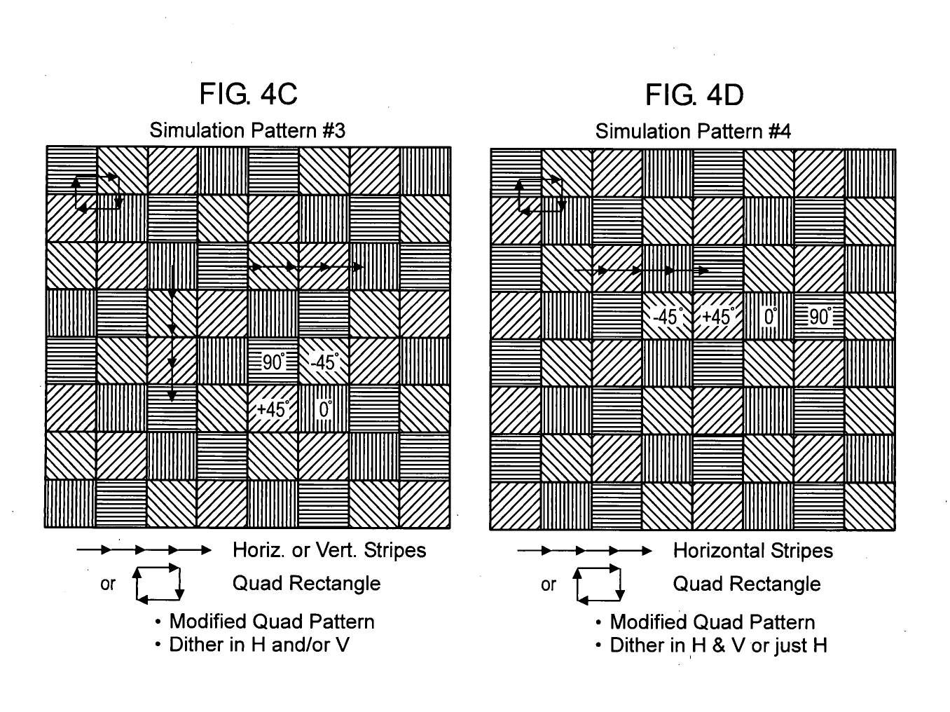

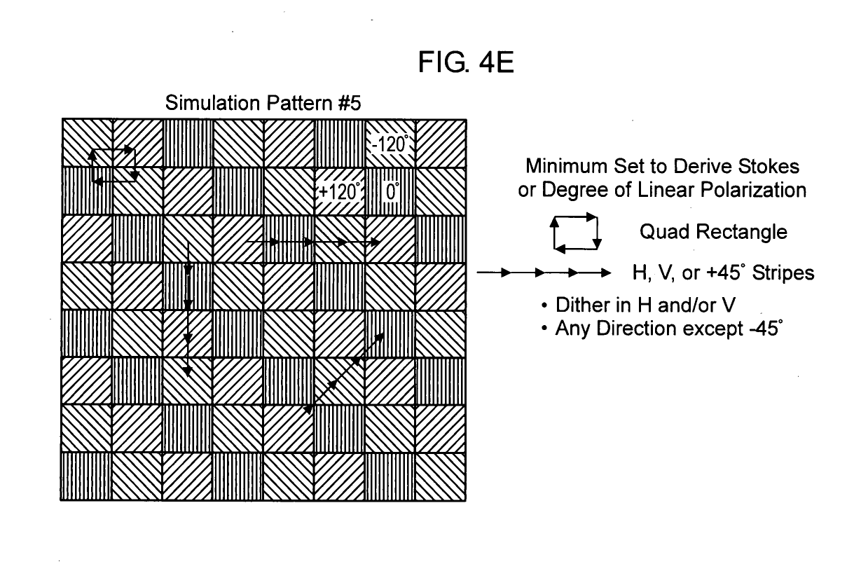

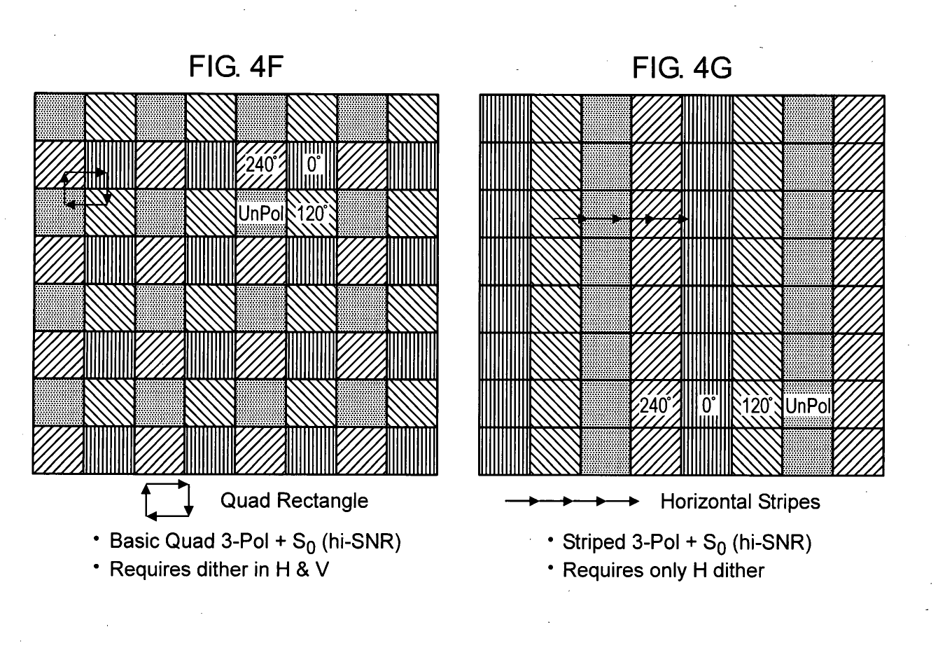

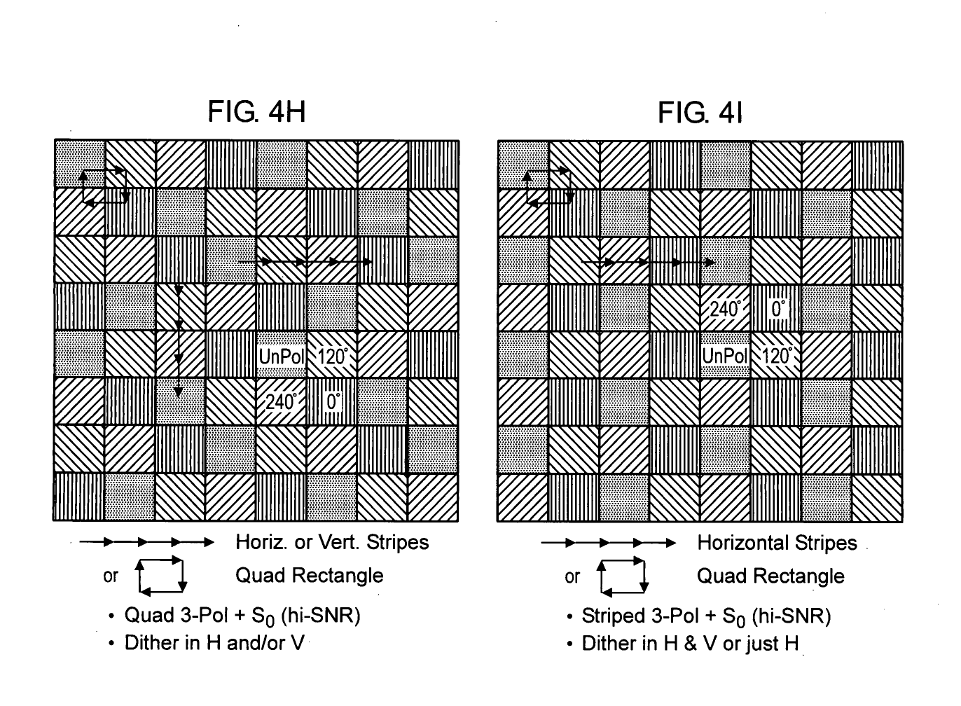

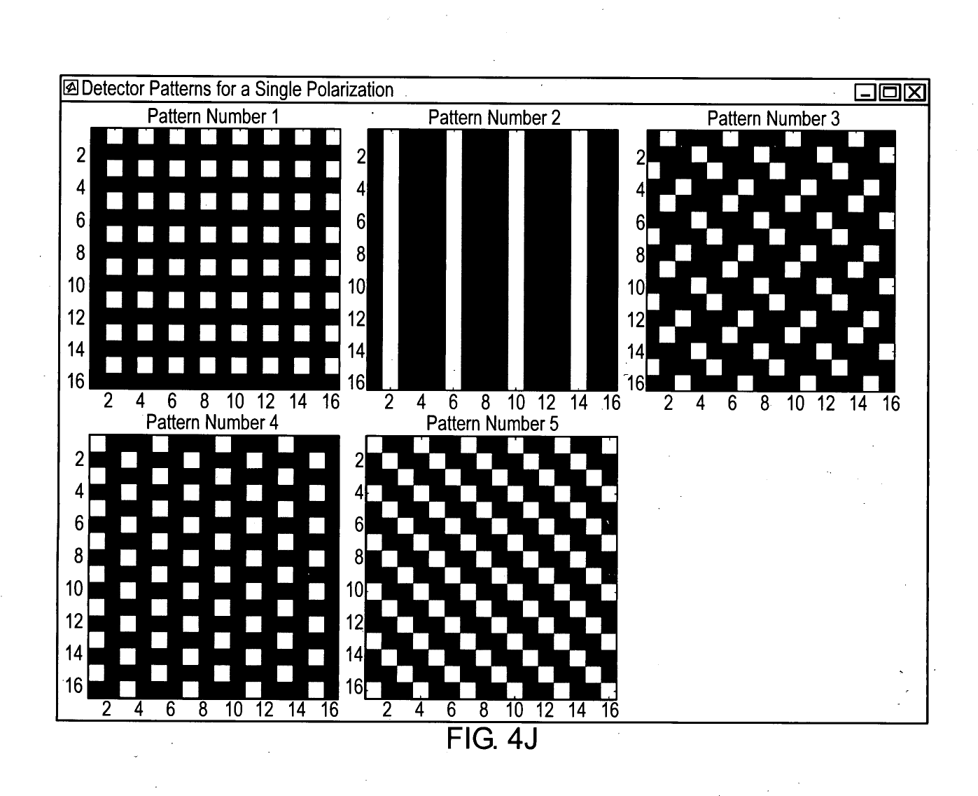

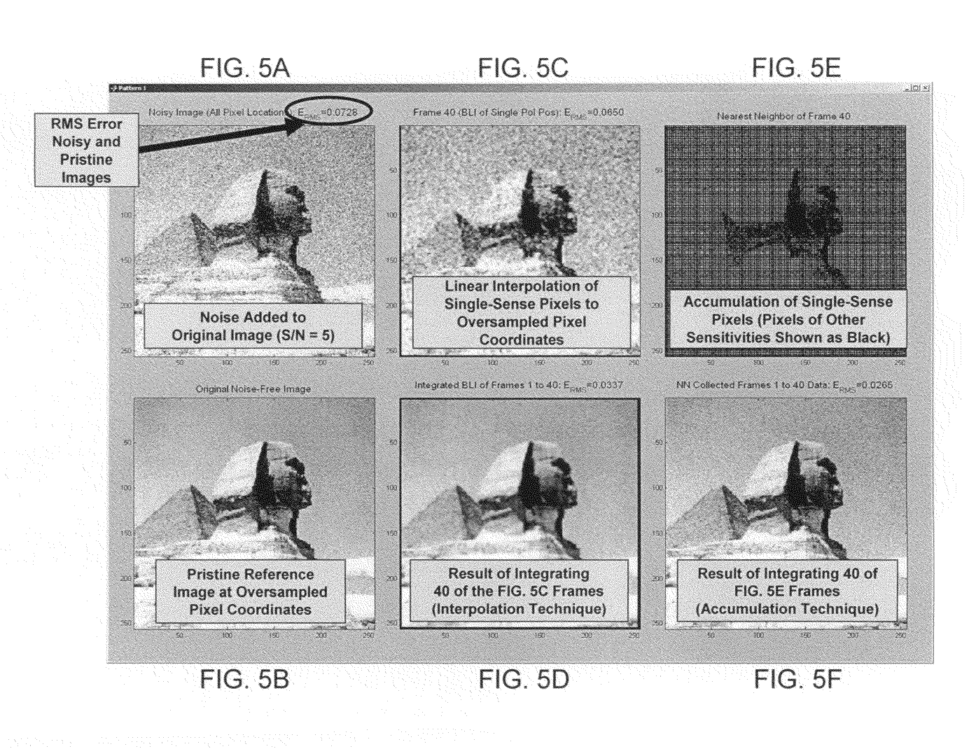

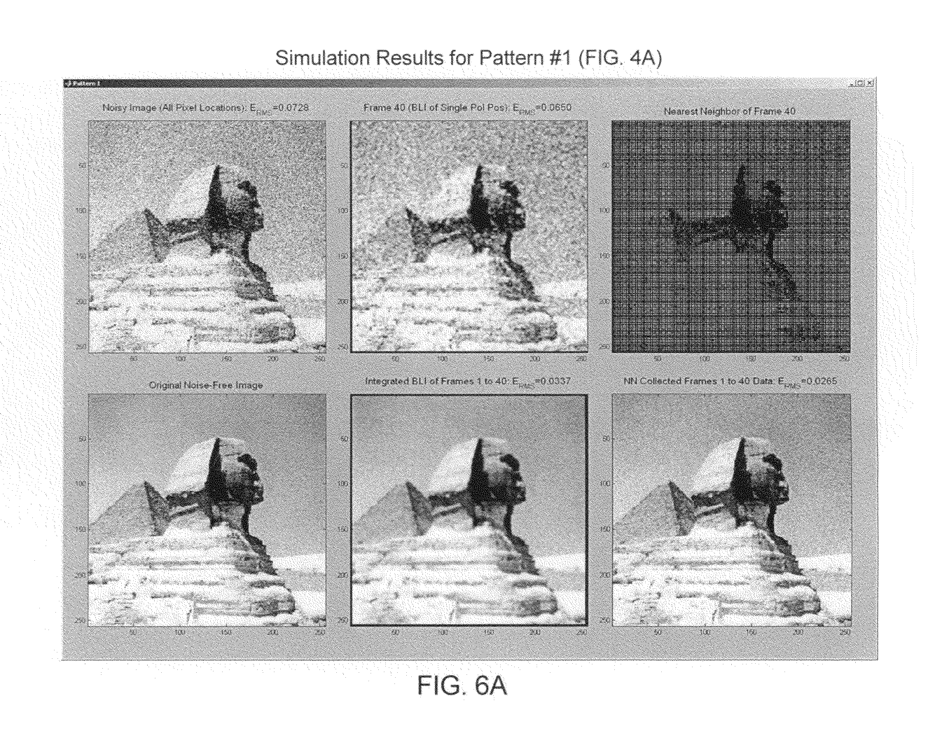

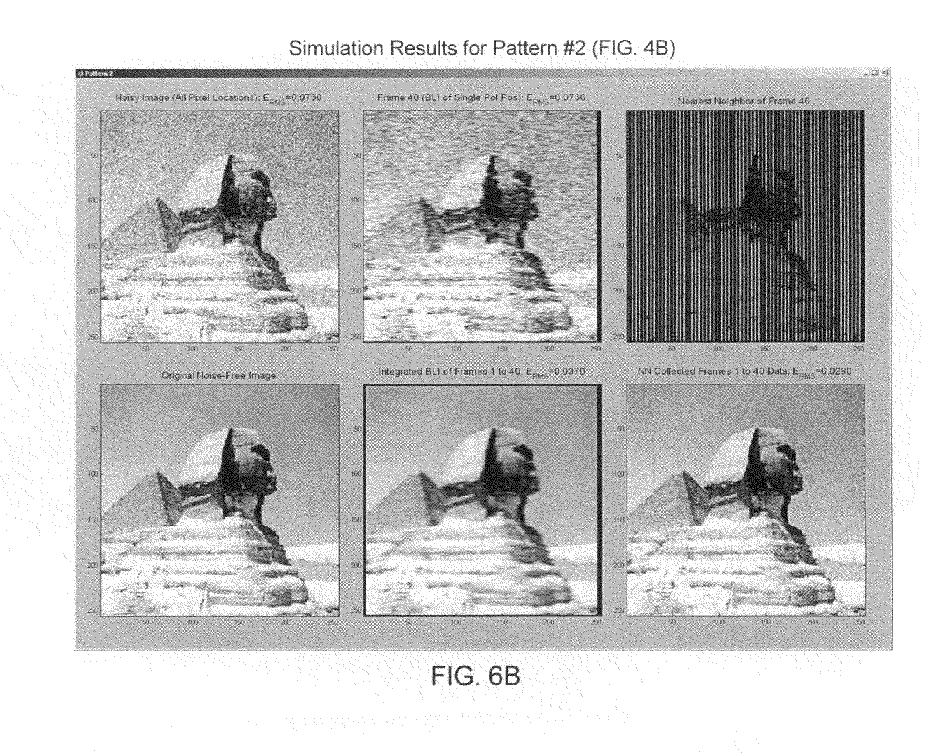

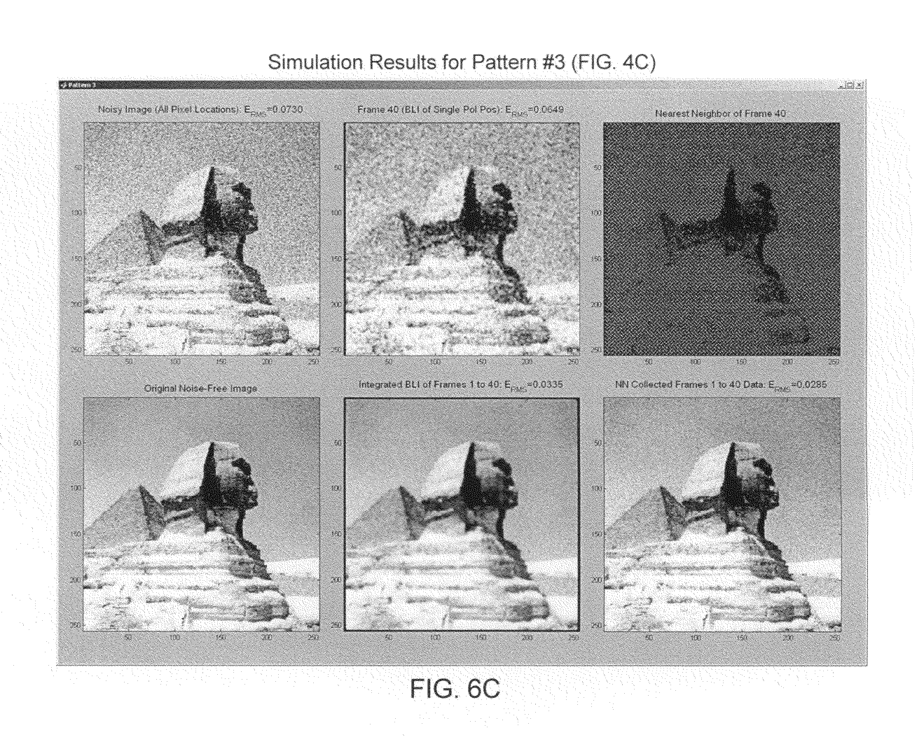

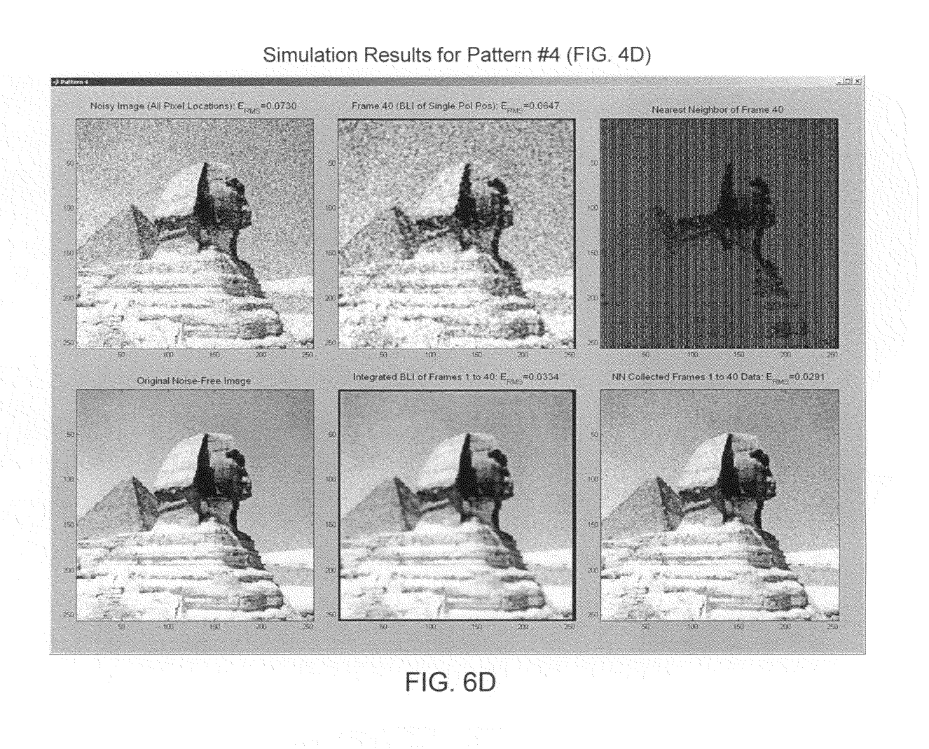

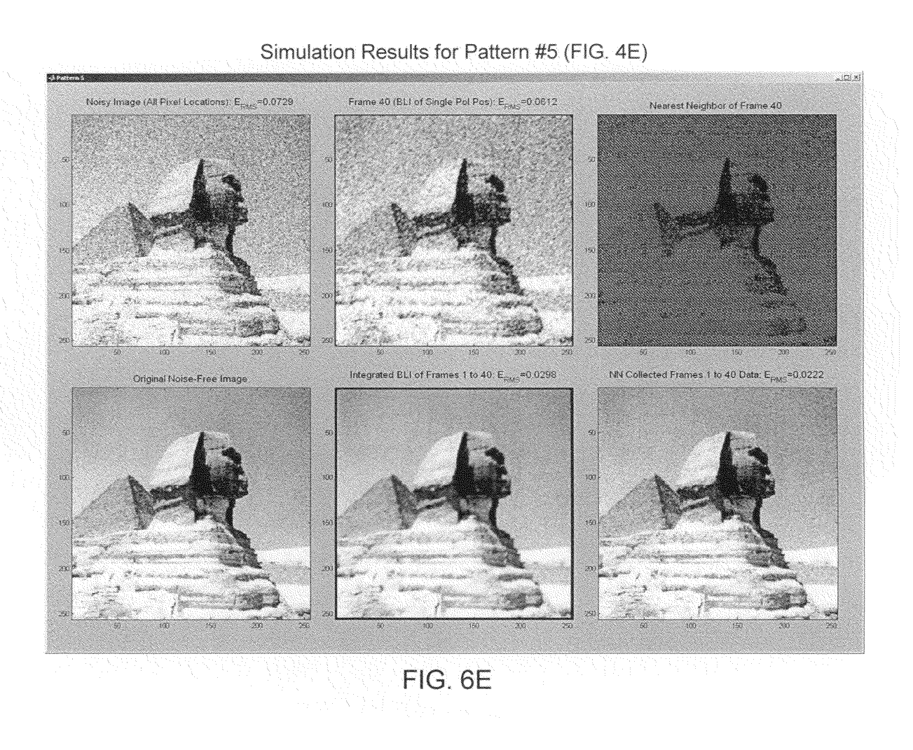

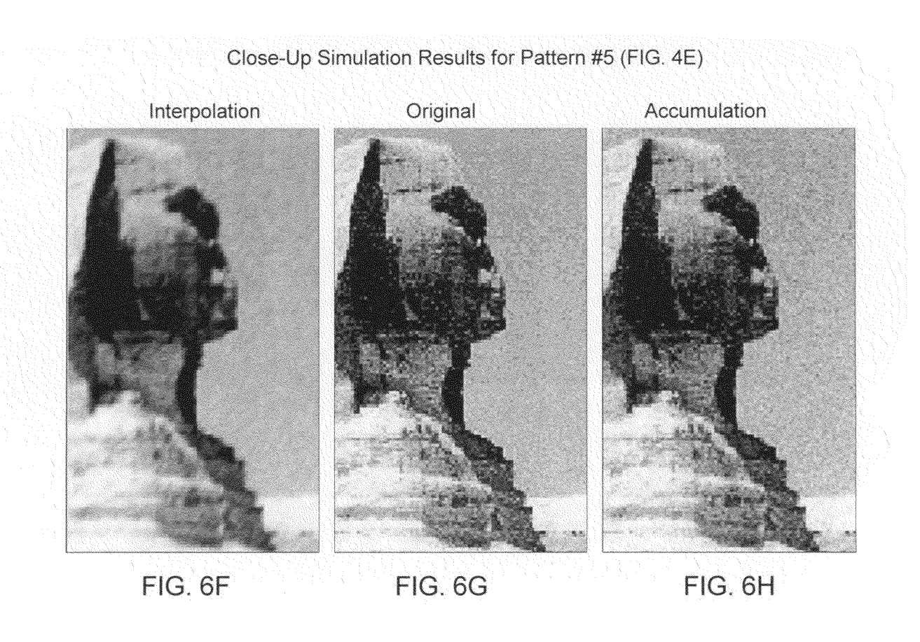

According to further embodiments of the present disclosure, an FPA can be divided to include basic repeating patterns of pixel elements of varying wavelength/waveband sensitivities (e.g., pixel elements sensitive to red, blue, or green wavelengths, pixel elements sensitive to short, mid, or long wavebands, etc.) and/or polarization sensitivities. FIGS. 4A-4I illustrate portions of a FPA having exemplary repeating patterns of pixel elements of varying polarization sensitivities. FIG. 4A illustrates an exemplary basic quad rectangle pattern that includes pixel elements of four different polarization sensitivities, 90 degrees, −45 degrees, 0 degrees and +45 degrees, arranged in repeating quad rectangles. As described herein, in one embodiment, dither can be introduced into the image capture system so that the undersampled frames will tend to produce pixel values to populate nearly all of the locations in the upsampled frame. For example, dither in a minimal circular pattern can produce samples of each sense polarization at all pixel locations for the basic quad pattern of FIG. 4A.

FIG. 4B illustrates an exemplary striped 4-polarization pattern that includes pixel elements of four different polarization sensitivities, +45 degrees, 0 degrees, −45 degrees and 90 degrees, arranged in repeating horizontal stripes. Dither in the horizontal direction can produce samples of each sense polarization at all pixel locations for the striped 4-polarization pattern of FIG. 4B. FIG. 4C illustrates an exemplary modified quad pattern that includes pixel elements of four different polarization sensitivities, 90 degrees, −45 degrees, 0 degrees and +45 degrees, arranged in repeating horizontal or vertical stripes or quad rectangles. Dither in a minimal circular pattern or in the horizontal and/or vertical directions can produce samples of each sense polarization at all pixel locations for the modified quad pattern of FIG. 4C. FIG. 4D illustrates another exemplary modified quad pattern that includes pixel elements of four different polarization sensitivities, +45 degrees, −45 degrees, 0 degrees and 90 degrees, arranged in repeating horizontal stripes or quad rectangles. Circular dither or dither in the horizontal direction can produce samples of each sense polarization at all pixel locations for the modified quad pattern of FIG. 4D. FIG. 4E illustrates an exemplary pattern that includes pixel elements of three different polarization sensitivities, +120 degrees, −120 degrees, and 0 degrees arranged in repeating horizontal, vertical, or +45 degree stripes or quad rectangles. This arrangement provides diversity in type of pixel element when traversing the array in any direction, except in the direction of −45 degrees. Circular dither or dither in the horizontal, vertical, or +45 degree directions can produce samples of each sense polarization at all pixel locations for the 3-polarization pattern of FIG. 4E.

FIG. 4F illustrates an exemplary basic quad rectangle pattern, similar to that illustrated in FIG. 4A, but includes pixel elements of three different polarization sensitivities, 240 degrees, 0 degrees and 120 degrees, as well as an unpolarized pixel element, arranged in repeating quad rectangles. The unpolarized pixel element does not include a polarization filter, making it more sensitive to incident photons and, therefore, yielding a higher SNR response. FIG. 4G illustrates an exemplary striped pattern, similar to that illustrated in FIG. 4B, but includes pixel elements of three different polarization sensitivities, 240 degrees, 0 degrees and 120 degrees, as well as an unpolarized pixel element, arranged in repeating horizontal stripes. FIG. 4H illustrates an exemplary modified quad pattern, similar to that illustrated in FIG. 4C, but includes pixel elements of three different polarization sensitivities, 240 degrees, 0 degrees and 120 degrees, as well as an unpolarized pixel element, arranged in repeating horizontal or vertical stripes or quad rectangles. FIG. 4I illustrates another exemplary modified quad pattern, similar to that illustrated in FIG. 4D, but includes pixel elements of three different polarization sensitivities, 240 degrees, 0 degrees and 120 degrees, arranged in repeating horizontal stripes or quad rectangles.

In other embodiments, a combination of polarizations and wavebands can be used. For example, the unpolarized elements of FIGS. 4F-4I could be of a different waveband than the three polarization elements, yielding image diversity in both waveband and polarization.

Moreover, according to embodiments of the present disclosure, the repeating pattern for a given FPA can be chosen to match a type of motion to be sampled or imaged, thereby optimizing image processing. For example, if the motion relative to the detector elements in the array is substantially linear and horizontal, a pattern such as the striped 4-polarization pattern illustrated in FIG. 4B may be selected. In general, the choice of pattern may affect the integration performance and can be selected to accommodate motion effects that are not easily controlled or accounted for, including optical flow due to platform motion and unknown range to the scene being imaged.

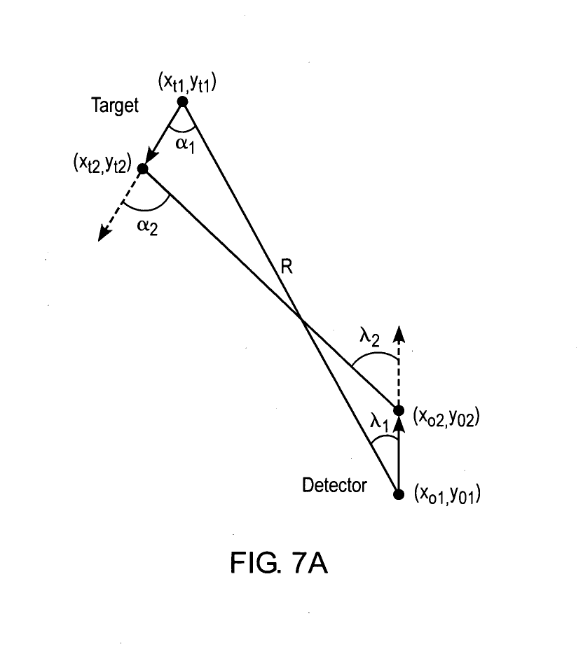

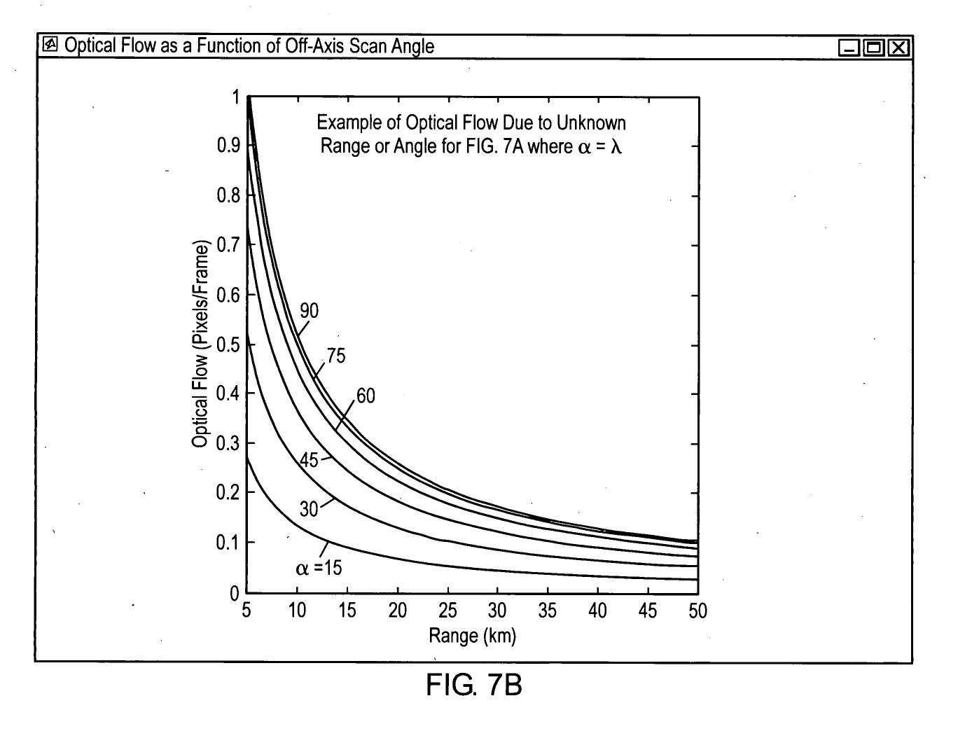

Optical flow describes detector-to-scene relative motion, such as the apparent motion of portions of the scene relative to the distance of the detector to those portions (e.g., portions of the scene that are closer to the detector appear to be moving faster than more distant portions). FIGS. 7A and 7B illustrate optical flow, particularly as a function of off-axis scan angle. FIG. 7A illustrates motion of a target relative to a detector, initially spaced a distance R apart. When the target is at a first location (xₜ₁, yₜ₁) and the detector is at a first location (xₒ₁, yₒ₁), the angle of the target's travel direction relative to the detector line-of-sight (LOS) is α₁ and the detector's LOS scan angle relative to the detector's travel direction is λ₁. When the target has moved to a second location (xₜ₂, yₜ₂) and the detector is at a second location (xₒ₂, yₒ₂), the angle of the target's travel direction relative to the detector LOS is α₂ and the detector's LOS scan angle relative to the detector's travel direction is λ₂.

FIG. 7B illustrates optical flow due to unknown range or angle for the example illustrated in FIG. 7A, where α=λ. FIG. 7B shows that, if range cannot be estimated, optical flow in a scene can vary significantly, particularly for larger values of the scan angle. This uncertainty in optical flow illustrates that the effective dither cannot, in most cases, be predictable and, therefore, must be considered random. The major direction of the dither, however, is often predictable based on the geometry of the application, and the robustness of the system may be enhanced by a proper selection of the detector pattern. For example, if detector scanning is predominantly within a horizontal plane (i.e., azimuth-only scanning, as in FIG. 7A), a striped pattern, such as that of FIG. 4B, would be an appropriate choice.

FIG. 4J illustrates exemplary single-sense detector patterns for a portion of a FPA. For example, as described herein, FIG. 4A illustrates a first pattern (“pattern I”) that includes four types of detector elements having polarization sensitivities of +45 degrees, 90 degrees, 0 degrees and −45 degrees. In FIG. 4J, pattern 1 is illustrated showing the positions occupied by one of the types of detectors, for example, the detectors having a polarization sensitivity of −45 degrees and blank spaces at the positions occupied by the three other types of detectors. Similarly, as described herein, FIG. 4B illustrates a second pattern (“pattern 2”) that includes four types of detector elements having polarization sensitivities of +45 degrees, 0 degrees, −45 degrees and 90 degrees. In FIG. 4J, pattern 2 is illustrated showing the positions occupied by one of the types of detectors, for example, the detectors having a polarization sensitivity of −45 degrees and blank spaces at the positions occupied by the three other types of detectors.

Likewise, FIG. 4C, described herein, illustrates a third pattern (“pattern 3”) that includes four types of detector elements having polarization sensitivities of +45 degrees, 90 degrees, −45 degrees and 0 degrees. In FIG. 4J, pattern 3 is illustrated showing the positions occupied by one of the types of detectors, for example, the detectors having a polarization sensitivity of −45 degrees and blank spaces at the positions occupied by the three other types of detectors. FIG. 4D, described herein, illustrates a fourth pattern (“pattern 4”) that includes four types of detector elements having polarization sensitivities of +45 degrees, −45 degrees, 90 degrees and 0 degrees. In FIG. 4J, pattern 4 is illustrated showing the positions occupied by one of the types of detectors, for example, the detectors having a polarization sensitivity of 90 degrees and blank spaces at the positions occupied by the three other types of detectors. Finally, FIG. 4E, described herein, illustrates a fifth pattern (“pattern 5”) that includes three types of detector elements having polarization sensitivities of +120 degrees, −120 degrees and 0 degrees. In FIG. 4J, pattern 5 is illustrated showing the positions occupied by one of the types of detectors, for example, the detectors having a polarization sensitivity of −120 degrees and blank spaces at the positions occupied by the two other types of detectors.

### Processing Simulation Results

An exemplary simulation was implemented to compare performance of the interpolation and accumulation processing techniques described herein. The exemplary repeating patterns illustrated in FIGS. 4A-4E correspond to patterns 1-5 used in the simulation. In the simulation, un-aliased samples of an image band-limited to 1/32nd of the sampling rate (i.e., 16-times the rate for un-aliased Nyquist sampling) were generated. The image was undersampled by a factor of 16 in the horizontal (H) and vertical (V) dimensions to produce a marginally Nyquist-sampled (un-aliased) representation of the image. Such an image could be shifted in 1/16th of a sample interval in H and/or V to closely represent any dither position for sampling the image (still un-aliased if all samples are used). Only a subset of samples from a series of the dithered images was chosen to represent a single polarization in the polarization pattern of the detector. These images were registered to simulate the intended registration process that removes the dither motion. On each frame, independent Gaussian noise samples were added to each pixel. The variance of the noise was chosen to produce an average SNR of 5:1 in each frame, simulating noisy image data.

To simulate the two processing techniques described herein, that is, the first processing technique 100 illustrated in FIG. 1, and the second processing technique 200, illustrated in FIGS. 2A and 2B, an upsampled image space was populated in two ways. To simulate the first technique, the upsampled image space was populated by bi-linearly interpolating (BLI) samples from the undersampled frame. All of the upsampled frames, thus constructed, were then averaged. To simulate the second technique, an aggregate of the data from multiple registered undersampled frames was collected, and each aggregated pixel value was assigned to a nearest quantized position in the upsampled image space. Multiple pixel values (e.g., obtained from multiple registered frames) to be assigned to the same upsampled location were first averaged and the averaged value was assigned to the upsampled location. A root-mean-square (RMS) error between the original noise-free image and an image reconstructed using each of the two processing techniques was calculated.

Comparative results of the simulated processing are illustrated in FIGS. 6A-6H. FIGS. 5A-5F provide a legend for interpreting the simulation results depicted in FIGS. 6A-6E. That is, as indicated in FIG. 5A, the top left image illustrates a frame of the unprocessed, noisy original image and, as indicated in FIG. 5B, the bottom left image illustrates a noise-free (or pristine) original image. As indicated in FIG. 5C, the top center image illustrates upsampled pixel locations populated by interpolating (in accordance with the first technique) single-sense pixels of the original noisy image and, as indicated in FIG. 5D, the bottom center image illustrates the resulting image after integration of forty of the upsampled frames populated according to the first technique of FIG. 5C. Additionally, as indicated in FIG. 5E, the top right image illustrates upsampled pixel locations populated by accumulating (in accordance with the second technique) single-sense pixels of a single original noisy image and, as indicated in FIG. 5F, the bottom right image illustrates the resulting image after integration of forty of the upsampled frames populated according to the second technique of FIG. 5E.

FIGS. 6A-6E illustrate a comparison of the simulation results for the interpolation processing (in accordance with the first technique) and the accumulation processing (in accordance with the second technique) for micropolarization patterns 1-5, respectively. FIGS. 6F-6H illustrate close-up portions of the resulting images for the simulation illustrated in FIG. 6G, based on pattern 5. FIG. 6F shows that the resulting image produced by the interpolation technique is blurred as compared to the original image illustrated in FIG. 6G and as compared to the resulting image illustrated in FIG. 6H produced by the accumulation technique.

TABLE 1 summarizes the results of the simulated processing illustrated in FIGS. 6A-6E. Patterns 1-5 identified in TABLE 1 correspond to the exemplary micropolarization patterns illustrated in FIGS. 4A-4E, described herein. These results indicate, among other observations, that the accumulation technique for processing undersampled images can achieve significantly higher integration efficiency, while achieving a resolution close to that of a closely spaced array (e.g., an array not divided by polarization or wavelength/waveband sensitivity).

TABLE 1
Comparison of Techniques for Processing Undersampled Images

| | Pattern | Pattern | Pattern | Pattern | Pattern |
|---|---|---|---|---|---|
| | #1 | #2 | #3 | #4 | #5 |
| # of Detector Pixel Types | 4 | 4 | 4 | 4 | 3 |
| RMS Noise/Detector Pixel | 0.073 | 0.073 | 0.073 | 0.073 | 0.073 |

Interpolation Processing (in accordance with the first technique)

| | | | | | |
|---|---|---|---|---|---|
| RMS Noise | 0.034 | 0.037 | 0.034 | 0.033 | 0.030 |
| Equivalent No. Frames | 4.7 | 3.9 | 4.7 | 4.8 | 6.0 |
| Integrated | | | | | |
| Integration Efficiency | 47% | 39% | 47% | 48% | 45% |
| Resolution | degraded | degraded | degraded | degraded | degraded |

Accumulation Processing (in accordance with the second technique)

| | | | | | |
|---|---|---|---|---|---|
| RMS Noise | 0.027 | 0.028 | 0.029 | 0.029 | 0.022 |
| Equivalent No. Frames | 7.5 | 6.8 | 6.6 | 6.3 | 10.8 |
| Integrated | | | | | |
| Integration Efficiency | 75% | 68% | 66% | 63% | 81% |
| Resolution | close to | close to | close to | close to | close to |
| | original | original | original | original | original |

All numbers expressing quantities or parameters used herein are to be understood as being modified in all instances by the term “about.” Notwithstanding that the numerical ranges and parameters set forth herein are approximations, the numerical values set forth are indicated as precisely as possible. For example, any numerical value inherently contains certain errors necessarily resulting from the standard deviation reflected by inaccuracies in their respective measurement techniques.

Although the present invention has been described in connection with embodiments thereof, it will be appreciated by those skilled in the art that additions, deletions, modifications, and substitutions not specifically described may be made without departing from the spirit and scope of the invention as defined in the appended claims.

What is claimed is:

1. A method for processing undersampled image data, comprising:
aligning an undersampled frame comprising image data to a reference frame;
accumulating pixel values for pixel locations in the aligned undersampled frame;
repeating the aligning and the accumulating for a plurality of undersampled frames;
assigning the pixel values accumulated for the pixel locations in the aligned undersampled frames to closest corresponding pixel locations in an upsampled reference frame; and
populating the upsampled frame with a combination of the assigned pixel values to produce a resulting frame of image data.

2. The method of claim 1, wherein the image data includes dithered image data.

3. The method of claim 1, wherein, if more than one pixel value is assigned to a given upsampled pixel location, the populating includes combining the assigned pixel values.

4. The method of claim 1, wherein, if unpopulated pixel locations exist in the upsampled frame after the populating, then the populating includes interpolating nearest populated upsampled pixel locations to generate pixel values for the unpopulated upsampled pixel locations.

5. The method of claim 1, wherein the image capture device includes a plurality of different types of detector elements.

6. The method of claim 5, wherein each undersampled frame comprises image data captured by a given type of the detector elements, and wherein the resulting frame comprises image data for the given type of detector element.

7. The method of claim 5, wherein the different types of detector elements include detector elements having different wavelength sensitivities or different polarization sensitivities.

8. The method of claim 5, wherein the different types of detector elements are arranged in an array according to a repeating pattern.

9. The method of claim 8, wherein the repeating pattern is selected according to motion characteristics of the image data being captured.

10. The method of claim 5, wherein the method is performed in parallel for each of the different types of detector elements of the image capture device to produce resulting frames for each of the different types of detector elements.

11. The method of claim 10, comprising:
combining the resulting frames for each of the different types of detector elements to produce a composite frame.

12. A method for processing undersampled image data, comprising:
aligning an undersampled frame comprising image data to a reference frame;
assigning pixel values for pixel locations in the aligned undersampled frame to closest corresponding pixel locations in an upsampled reference frame;
combining, for each upsampled pixel location, the pixel value or values assigned to the upsampled pixel location with a previously combined pixel value for the upsampled pixel location and incrementing a count of the number of pixel values assigned to the upsampled pixel location;
repeating the aligning, the assigning, and the combining for a plurality of undersampled frames; and
normalizing, for each upsampled pixel location, the combined pixel value by the count of the number of pixel values assigned to the upsampled pixel location to produce a resulting frame of image data.

13. The method of claim 12, wherein the image data includes dithered image data.

14. The method of claim 12, wherein the image capture device includes a plurality of different types of detector elements.

15. The method of claim 14, wherein each undersampled frame comprises image data captured by a given type of the detector elements, and wherein the resulting frame comprises image data for the given type of detector element.

16. The method of claim 14, wherein the different types of detector elements include detector elements having different wavelength sensitivities or different polarization sensitivities.

17. The method of claim 14, wherein the different types of detector elements are arranged in an array according to a repeating pattern.

18. The method of claim 17, wherein the repeating pattern is selected according to motion characteristics of the image data being captured.

19. The method of claim 14, wherein the method is performed in parallel for each of the different types of detector elements of the image capture device to produce resulting frames for each of the different types of detector elements.

20. The method of claim 19, comprising:
combining the resulting frames for each of the different types of detector elements to produce a composite frame.

21. A system for processing undersampled image data, comprising:
an image capture device; and
a processing device configured to process a plurality of undersampled frames comprising image data captured by the image capture device,
wherein the processing device is configured to process the undersampled frames by aligning each undersampled frame to a reference frame, accumulating pixel values for pixel locations in the aligned undersampled frames, assigning the pixel values accumulated for the pixel locations in the aligned undersampled frames to closest corresponding pixel locations in an upsampled reference frame, and populating the upsampled frame with a combination of the assigned pixel values to produce a resulting frame of image data.

22. The system of claim 21, wherein the image data includes dithered image data.

23. The system of claim 21, wherein the image capture device comprises:
a focal place array.

24. The system of claim 21, wherein the image capture device includes a plurality of different types of detector elements.

25. The system of claim 24, wherein each undersampled frame comprises image data captured by a given type of the detector elements, and wherein the resulting frame comprises image data for the given type of detector element.

26. The system of claim 24, wherein the different types of detector elements include detector elements having different wavelength sensitivities or different polarization sensitivities.

27. The system of claim 24, wherein the different types of detector elements are arranged in an array according to a repeating pattern.

28. The system of claim 27, wherein the repeating pattern is selected according to motion characteristics of the image data being captured.

29. The system of claim 24, wherein the processing device is configured to process undersampled frames for each of the different types of detector elements in parallel to produce resulting frames for each of the different types of detector elements.

30. The system of claim 29, wherein the processing device is configured to combine the resulting frames for each of the different types of detector elements to produce a composite frame.

31. The system of claim 30, comprising:
a display device configured to display the composite image.

32. The system of claim 30, wherein the processing device is configured to process the composite image in accordance with a target recognition or target tracking application.

33. The system of claim 21, wherein, if more than one pixel value is assigned to a given upsampled pixel location, the processing device is configured to combine the assigned pixel values.

34. The system of claim 21, wherein, if unpopulated pixel locations exist in the upsampled frame after the populating, the processing device is configured to interpolate nearest populated upsampled pixel locations to generate pixel values for the unpopulated upsampled pixel locations.

35. A system for processing undersampled image data, comprising:
an image capture device; and
a processing device configured to align an undersampled frame comprising image data captured by the image capture device to a reference frame, assign pixel values for pixel locations in the aligned undersampled frame to closest corresponding pixel locations in an upsampled reference frame, and combine, for each upsampled pixel location, the pixel value or values assigned to the upsampled pixel location with a previously combined pixel value for the upsampled pixel location and increment a count of the number of pixel values assigned to the upsampled pixel location,
wherein the processing device is configured to repeat the aligning, the assigning, and the combining for a plurality of undersampled frames and, for each upsampled pixel location, normalize the combined pixel value by the count of the number of pixel values assigned to the upsampled pixel location to produce a resulting frame of image data.

36. The system of claim 35, wherein the image data includes dithered image data.

37. The system of claim 35, wherein the image capture device comprises:
a focal place array.

38. The system of claim 35, wherein the image capture device includes a plurality of different types of detector elements.

39. The system of claim 38, wherein each undersampled frame comprises image data captured by a given type of the detector elements, and wherein the resulting frame comprises image data for the given type of detector element.

40. The system of claim 38, wherein the different types of detector elements include detector elements having different wavelength sensitivities or different polarization sensitivities.

41. The system of claim 38, wherein the different types of detector elements are arranged in an array according to a repeating pattern.

42. The system of claim 41, wherein the repeating pattern is selected according to motion characteristics of the image data being captured.

43. The system of claim 38, wherein the processing device is configured to process undersampled frames for each of the different types of detector elements in parallel to produce resulting frames for each of the different types of detector elements.

44. The system of claim 43, wherein the processing device is configured to combine the resulting frames for each of the different types of detector elements to produce a composite frame.

45. The system of claim 44, comprising:
a display device configured to display the composite image.

46. The system of claim 44, wherein the processing device is configured to process the composite image in accordance with a target recognition or target tracking application.
